(19) United States
(12) Patent Application Publication
(10) Pub. No.: US 2021/0173472 A1
(43) Pub. Date: Jun. 10, 2021

(54) SYSTEM AND METHOD FOR PERFORMING CONSTELLATION GAME USING VIRTUAL REALITY

(71) Applicant: Sejong Industry-Academia Cooperation Foundation Hongik University, Sejong-si (KR)

(72) Inventor: Gapyuel Seo, Seoul (KR)

(21) Appl. No.: 17/112,021

(22) Filed: Dec. 4, 2020

(30) Foreign Application Priority Data
Dec. 10, 2019 (KR) 10-2019-0163546

(51) Int. Cl. G06F 3/01; G02B 27/01; G06T 19/00

(52) U.S. Cl. CPC G06F 3/011; G06T 19/006; G02B 27/017

(57) ABSTRACT

This application relates to a system and method for performing a constellation game using virtual reality. In one aspect, the constellation game is played using a wearable input device in a state that a user is mounted with a head mounted display (HMD). The system and method may be configured so that when a user is provided with a celestial image according to a user gaze direction to select a constellation after starting the game, an image of dots on an outline of the selected constellation is provided. When the dots are connected to each other, a constellation image and illustration and storytelling information corresponding to the constellation are provided.

### CROSS REFERENCE TO RELATED APPLICATION

The present application claims priority to Korean Patent Application No. 10-2019-0163546, filed Dec. 10, 2019, the entire contents of which is incorporated herein for all purposes by this reference.

### BACKGROUND

### Technical Field

The described technology relates to a system and method for performing a constellation game using virtual reality.

### Description of the Related Technology

In general, the constellation can be easily appreciated and observed by anyone, regardless of gender, regardless of location. However, because ordinary people lack knowledge about constellations, they find it difficult to understand the constellations and easily get bored with them. In order to compensate for such shortcomings, several mechanisms have been proposed.

### SUMMARY

One aspect is a system and method for performing a constellation game using virtual reality, the constellation game being played using a wearable input device in a state that a user is mounted with a head mounted display (HMD), the system and method being configured so that when a user is provided with a celestial image according to a user gaze direction to select a constellation after starting the game, an image of dots on an outline of the selected constellation is provided, and when the dots are connected to each other, a constellation image and illustration and storytelling information corresponding to the constellation are provided.

Another aspect is a system and method for performing a constellation game using virtual reality, the system and method being configured to be capable of enhancing learning effects by drawing interest in constellations.

Another aspect is a system for performing a constellation game using virtual reality including a head mounted display (HMD) that a display device worn on a user's head; a user gaze direction detection unit configured to detect a direction that a user gazes; a wearable input device worn on a user's body, provided with a game start button for inputting a game start command, and configured to select a constellation and connect dots on an outline of the constellation to each other; and a control device configured so that, when the game start button of the wearable input device is clicked, a user gaze direction is checked through the user gaze direction detection unit to provide the HMD with a celestial image according to the user gaze direction; when any one constellation is selected on the celestial image by the wearable input device, an image of dots on an outline of the selected constellation is provided with the HMD; and when the dots on the outline are connected to each other by the wearable input device, an image of the selected constellation, a mixed image obtained by inserting an illustration into the image of the constellation, and storytelling information on the constellation are provided.

According to an embodiment, the control device may include a celestial image providing unit configured so that a user gaze direction is checked through the user gaze direction detection unit to provide the HMD with a celestial image according to the user gaze direction; a constellation dot image providing unit configured so that when any one constellation is selected on the celestial image by the wearable input device, an image of dots on an outline of the selected constellation is provided with the HMD; a constellation image providing unit configured so that when the dots on the outline are connected to each other by the wearable input device, an image of the selected constellation is provided; an illustration providing unit configured to provide a mixed image obtained by inserting an illustration into the image of the constellation provided by the constellation image providing unit; and a constellation storytelling information providing unit configured to provide storytelling information for the mixed image provided by the illustration providing unit.

According to an embodiment, the storytelling information may include scientific knowledge related to the constellation and storytelling information related to the constellation in Greek mythology and legend.

Another aspect is a method of performing a constellation game including clicking a game start button of a wearable input device; checking, by a control device, a user gaze direction through a user gaze direction detection unit; providing, by the control device, a celestial image according to the user gaze direction to a head mounted display (HMD); selecting any one constellation on the celestial image by the wearable input device; providing, by the control device, an image of dots on an outline of the selected constellation to the HMD; determining, by the control device, whether the dots on the outline are connected to each other by the wearable input device; when the dots on the outline are determined to be connected to each other in the determining, providing, by the control device, the HME with an image of the constellation on which the dots are connected to each other; providing, by the control device, the HME with a mixed image obtained by inserting an illustration into the image of the constellation; and providing, by the control device, the HMD with storytelling information on the mixed image of the constellation.

A system and method for performing a constellation game using virtual reality according to an embodiment of the described technology is configured so that, when the game start button of the wearable input device is clicked, the user gaze direction is checked through the user gaze direction detection unit to provide the HMD with a celestial image according to the user gaze direction; when any one constellation on the celestial image is selected by the wearable input device, an image of dots on the outline of the selected constellation is provided with the HMD; and when the dots on the outline are connected to each other by the wearable input device, an image of the selected constellation, a mixed image obtained by inserting an illustration into the image of the corresponding constellation, and storytelling information about the corresponding constellation are provided, whereby it is possible to enhance learning effects by drawing interest in learning about constellations.

### BRIEF DESCRIPTION OF THE DRAWINGS

The above and other objects, features and other advantages of the described technology will be more clearly understood from the following detailed description when taken in conjunction with the accompanying drawings.

FIG. 1 is a block diagram showing a system for performing a constellation game using virtual reality according to an embodiment of the described technology.

FIG. 2 is a diagram showing a celestial image displayed through an HMD in a state that the HMD of FIG. 1 is mounted on a user.

FIG. 3A is a diagram showing an image displayed through the HMD of FIG. 1, in which an image of dots on an outline of the constellation is provided by a constellation dot image providing unit and some of the dots are connected to each other by a wearable input device.

FIG. 3B is a diagram showing a constellation image provided by a constellation image provider.

FIG. 3C is a diagram showing a mixed image provided by the constellation illustration provider.

FIG. 3D is a diagram showing storytelling information for the mixed image provided by a constellation storytelling information provider.

FIG. 4 is an operation flow chart showing a method for performing a constellation game according to an embodiment of the described technology.

### DETAILED DESCRIPTION

There is a method of projecting images of stars or constellations onto a constellation observation hemisphere and providing them to the user. However, since such a method is a learning method that unilaterally provides the constellation and detailed information of the constellation to a participant regardless of a participant's intention, there are problems that the participant's learning effect decreases and the participant may lose interest in learning about constellations.

In describing the embodiments of the described technology, when it is determined that a detailed description of known technologies related to the described technology may unnecessarily obscure the subject matter of the described technology, a detailed description thereof will be omitted. In addition, terms to be described later are terms defined in consideration of functions in the described technology, which may vary according to the intention or custom of users or operators. Therefore, the definition should be made on the basis of contents throughout this specification. The terms used in the detailed description are only for describing the embodiments of the described technology and should not be construed as limiting. Unless explicitly used otherwise, expressions in the singular form include the meaning of the plural form. In this description, expressions such as “comprising” or “including” are intended to refer to certain features, numbers, steps, actions, elements, and some or combination thereof, and should not be construed as excluding the presence or possibility of one or more other features, numbers, steps, actions, elements, and some or combination thereof other than those described.

In each of systems shown in the drawings, elements in some cases each have the same reference number or a different reference number, suggesting that the elements represented may be different or similar. However, the elements may have different implementations and work with some or all of the systems shown or described herein. The various elements shown in the figures may be the same or different. Which is referred to as the first element and which is referred to as the second element is arbitrary.

In this specification, when one component “transmits”, “delivers”, or “provides” data or signals to another component, this includes transmitting data or signals directly from one component to another, as well as transmitting data or signals to another component through at least one other component.

Hereinafter, embodiments of the described technology will be described in detail with reference to the drawings.

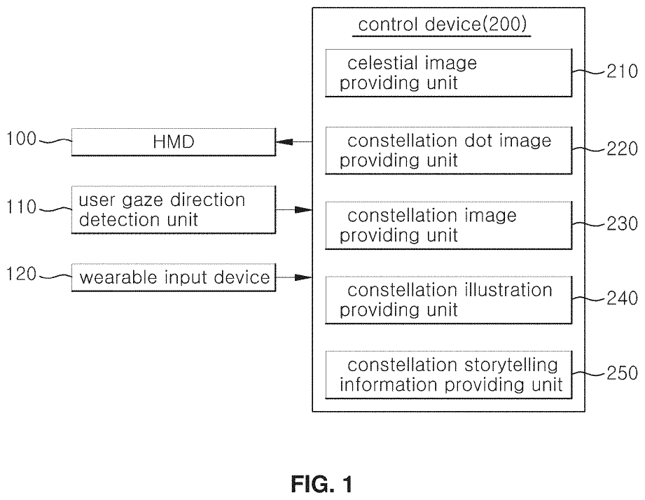

FIG. 1 is a block diagram showing a system for performing a constellation game using virtual reality according to an embodiment of the described technology.

A system for performing a constellation game using virtual reality according to an embodiment of the described technology includes a HMD 100, a user gaze direction detection unit (or a user gaze direction detector or user gaze direction detection sensor) 110, a wearable input device 120, and a control device (or a controller) 200, as shown in FIG. 1.

The HMD 100 is a display device worn on the user's head, and provides, from the control device 200, images such as a celestial image, a dot image on an outline of a constellation, a constellation image, a mixed image obtained by inserting an illustration into the constellation image, and constellation storytelling information.

The user gaze direction detection unit 110 is mounted on the HMD 100 and serves to detect the direction the user gazes and provide a detection signal to the control device 200. The user gaze direction detection unit 110 may detect a direction that the user gazes from 0 to 360 degrees.

The wearable input device 120 is worn on the user's body and serves to input the user's command to the control device 200. In addition, the wearable input device 120 includes function selection buttons such as a game start button, a game end button, and a game menu selection button, and an input tool used for selecting a constellation and connecting dots on an outline of the constellation to each other.

The control device 200 receives a user gaze direction detection signal from the user gaze direction detection unit 110 and serves to operate according to an input signal provided by the wearable input device 120 to provide an image for a constellation game to the HMD 100.

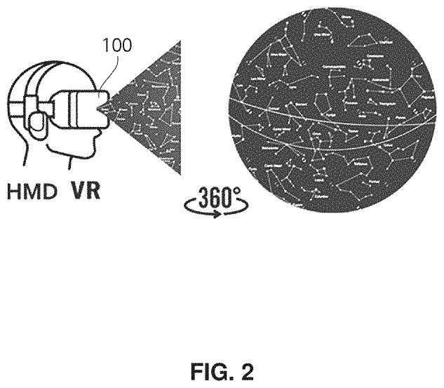

Specifically, when the game start button of the wearable input device 120 is clicked, the control device 200: checks the user gaze direction through the user gaze direction detection unit 110 to provide the HMD 100 with a celestial image (see FIG. 2) according to the user gaze direction; when any one constellation on the celestial image is selected by the wearable input device 120, provides the HMD 100 with an image of dots on the outline of the selected constellation; and when the dots on the outline are connected to each other by the wearable input device 120, provides the HMD 100 with an image of the selected constellation, a mixed image obtained by inserting an illustration into the image of the corresponding constellation, and storytelling information about the corresponding constellation.

The storytelling information may include scientific knowledge related to the constellation and storytelling information related to the constellation in Greek mythology and legend.

The control device 200 includes a celestial image providing unit (or a celestial image processor) 210, a constellation dot image providing unit (or a constellation dot image processor) 220, a constellation image providing unit (or a constellation image processor) 230, a constellation illustration providing unit (or a constellation illustration processor) 240, and a constellation storytelling information providing unit (a constellation storytelling information processor) 250.

The celestial image providing unit 210 serves to check the user gaze direction through the user gaze direction detection unit 110 and provide the HMD 100 with a celestial image according to the user gaze direction. The celestial image providing unit 210 provides the celestial image for all angles (0 to 360 degrees) in the direction that the user gazes, whereby the user may see all the celestial bodies in the night sky.

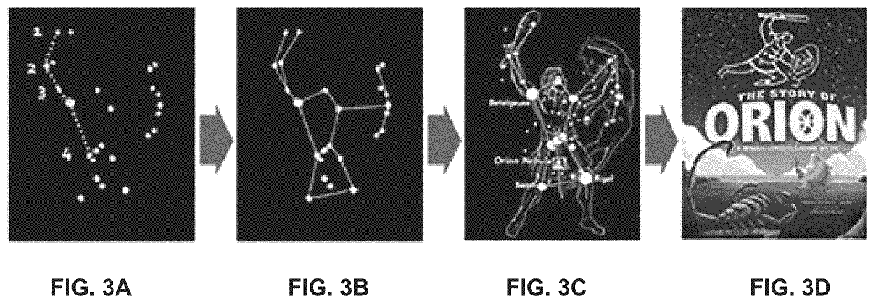

When any one constellation (e.g., Orion) is selected on the celestial image by the wearable input device 120, the constellation dot image providing unit 220 serves to provide the HMD 100 with an image of dots (see FIG. 3A) on an outline of the selected constellation.

When the dots on the outline of the constellation is connected to each other by the wearable input device 120, FIG. 3A shows some dots, that is, dots 1, 2, 3, and 4 on the outline of the Orion constellation are connected to each other), the constellation image providing unit 230 provides an image of the selected constellation (see FIG. 3B)

The constellation illustration providing unit 240 serves to provide a mixed image (see FIG. 3C) obtained by inserting an illustration into the constellation image provided by the constellation image providing unit 230.

The constellation storytelling information providing unit 250 serves to provide storytelling information (see FIG. 3D) for the mixed image provided by the constellation illustration providing unit 240.

A method for performing a constellation game using a constellation system using virtual reality according to an embodiment of the described technology configured as described above will be described with reference to the drawings.

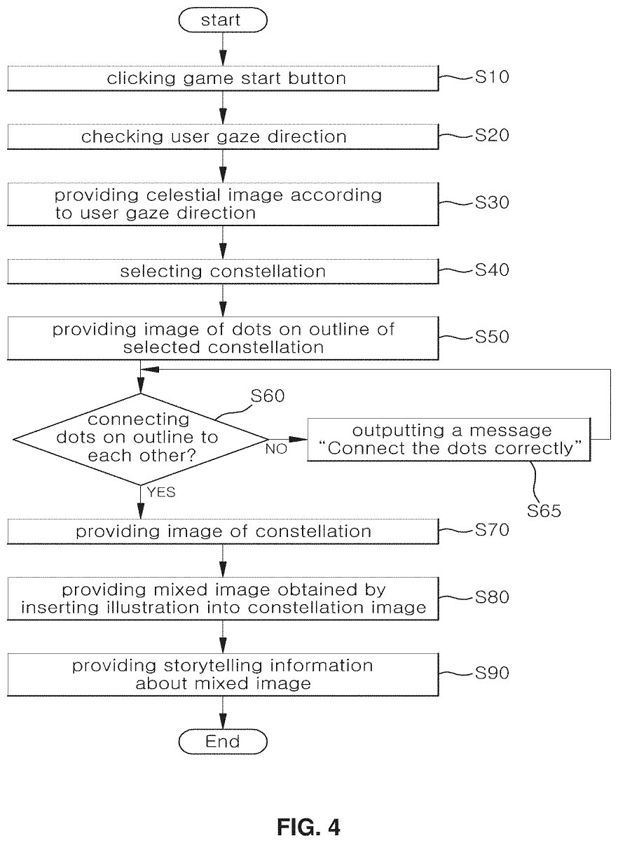

FIG. 4 is an operation flow chart showing a method for performing a constellation game according to an embodiment of the described technology, where S denotes a step.

First, when the user clicks the game start button of the wearable input device 120 (S10), the control device 200 checks a user gaze direction through the user gaze direction detection unit 110 (S20), and provides the HMD 100 with a celestial image according to the user gaze direction as shown in FIG. 2 (S30).

Subsequently, any one constellation on the celestial image is selected by the wearable input device 120 (S40), and the control device 200 provides the HMD 100 with an image of dots on the outline of the constellation selected as shown in FIG. 3A (S50).

Next, the control device 200 determines whether or not the dots on the outline are connected to each other by the wearable input device 120 (S60).

When the dots on the outline are connected to each other in the step S60 (YES), the control device 200 provides the HMD 100 with an image of the constellation with the dots connected as shown in FIG. 3B (S70), provides the HMD 100 with a mixed image obtained by inserting an illustration into the constellation image as shown in FIG. 3C (S80), and then provides the HMD 100 with storytelling information about the constellation of the mixed image as shown in FIG. 3D.

Meanwhile, when the dots on the outline are not connected to each other in step S60 (NO), the control device 200 outputs a message “Connect the dots correctly” to the HMD 100 (S65), and proceeds to step S60.

A system and method for performing a constellation game using virtual reality according to an embodiment of the described technology is configured so that, when the game start button of the wearable input device is clicked, the user gaze direction is checked through the user gaze direction detection unit to provide the HMD with a celestial image according to the user gaze direction; when any one constellation on the celestial image is selected by the wearable input device, an image of dots on the outline of the selected constellation is provided with the HMD; and when the dots on the outline are connected to each other by the wearable input device, an image of the selected constellation, a mixed image obtained by inserting an illustration into the image of the corresponding constellation, and storytelling information about the corresponding constellation are provided, whereby it is possible to enhance learning effects by drawing interest in constellations.

In the drawings and specification, although an optimal embodiment has been disclosed, and specific terms have been used, this is used only for the purpose of describing the embodiments of the described technology, and is not used to limit the meaning or the scope of the described technology described in the claims. Therefore, those of ordinary skill in the art will understand that various modifications and equivalent other embodiments are possible therefrom. Therefore, the true technical scope of the described technology should be determined by the technical spirit of the appended claims.

What is claimed is:

1. A system for performing a constellation game using virtual reality, the system comprising:
a head mounted display (HMD) configured to be worn on a user's head;
a user gaze direction detector configured to detect a direction that the user gazes;
a wearable input device configured to be worn on the user's body, the wearable input device comprising a game start button configured to receive a game start command, the wearable input device configured to select a constellation and connect dots on an outline of the constellation to each other; and
a controller configured to:
in response to the game start command being received, control the user gaze direction detector to detect a user gaze direction and provide to the HMD a celestial image according to the user gaze direction;
in response to any one constellation being selected on the celestial image by the wearable input device, provide an image of dots on an outline of the selected constellation to the HMD; and
in response to the dots on the outline being connected to each other by the wearable input device, provide to the HMD an image of the selected constellation, a mixed image obtained by inserting an illustration into the image of the constellation, and storytelling information on the constellation.

2. The system of claim 1, wherein the controller comprises:
a celestial image processor configured to detect the user gaze direction and provide the celestial image according to the user gaze direction to the HMD;
a constellation dot image processor configured to provide the image of the dots on the outline of the selected constellation to the HMD in response to any one constellation being selected on the celestial image by the wearable input device;
a constellation image processor configured to provide the image of the selected constellation in response to the dots on the outline being connected to each other by the wearable input device;
an illustration processor configured to provide a mixed image obtained by inserting the illustration into the image of the constellation provided by the constellation image processor; and
a constellation storytelling information processor configured to provide the storytelling information for the mixed image provided by the illustration processor.

3. The system of claim 1, wherein the storytelling information includes scientific knowledge related to the constellation and storytelling information related to the constellation in Greek mythology and legend.

4. A method of performing a constellation game using a virtual reality system, the method comprising:
receiving, by a controller of the virtual reality system, a game start command from a wearable input device of the virtual reality system worn on a user's body;
detecting, by a user gaze direction detector of the virtual reality system, a user gaze direction;
providing, by the controller, a celestial image according to the user gaze direction to a head mounted display (HMD) of the virtual reality system;
receiving, by the controller, a selection of any one constellation on the celestial image by the wearable input device;
providing, by the controller, an image of dots on an outline of the selected constellation to the HMD;
determining, by the controller, whether the dots on the outline are connected to each other by the wearable input device;
when the dots on the outline are connected to each other, providing, by the controller, an image of the constellation on which the dots are connected to each other to the HMD;
providing, by the controller, a mixed image obtained by inserting an illustration into the image of the constellation to the HMD; and
providing, by the controller, storytelling information on the mixed image of the constellation to the HMD.

5. The method of claim 4, wherein the storytelling information includes scientific knowledge related to the constellation and storytelling information related to the constellation in Greek mythology and legend.
